(19) United States
(12) Patent Application Publication
(10) Pub. No.: US 2007/0251154 A1
(43) Pub. Date: Nov. 1, 2007

(54) Lapping Composition and Method Using Same

(76) Inventor: John L. Lombardi, Tucson, AZ (US)

Correspondence Address: Dale F Regelman;Law Office of Dale F Regelman, 4231 S Fremont Avenue, Tucson, AZ, 85714, US

(21) Appl. No.: 10/588,039

(22) PCT Filed: Feb. 3, 2005
(86) PCT No.: PCT/US05/03264

§ 371 Date: Jun. 11, 2007

Related U.S. Application Data
(60) Provisional application No. 60/542,058, filed on Feb. 4, 2004.
(60) Provisional application No. 60/566,699, filed on Apr. 30, 2004.

(51) Int. Cl. C09K 3/14; B22D 7/10

(52) U.S. Cl. 51/298; 164/6

(57) ABSTRACT

Lapping compositions are disclosed which comprise a fluid useful during a process to shape the surface of a substrate, where that process includes contacting a target surface of the substrate with one or more abrasives while also contacting that target surface with the lapping composition.

### CROSS REFERENCE TO RELATED APPLICATIONS

This Application claims priority from a U.S. Provisional Application having Ser. No. 60/542,058, and from a U.S. Provisional Application having Ser. No. 60/566,699.

### FIELD OF THE INVENTION

The invention relates to a composition for use in grinding, cutting, and/or polishing the surface of ceramic and/or metallic objects.

### BACKGROUND OF THE INVENTION

Lapping, grinding, cutting, and polishing, collectively referred to herein as “lapping,” are key manufacturing technologies for shaping various ceramic and metallic materials. Lapping provides a mechanism to shape the surface of a substrate.

Lapping is often performed using a versatile, high-precision polishing machine using a scrolled cast iron plate. The machine generally includes a reciprocating roller bar mechanism to hold the sample in position while allowing for constant plate conditioning during the preparation process. In some applications, the lapping comprises a medium grit (10 to 15 micron) silicon carbide powder, suspended in a lapping composition. Other abrasive materials include medium grit aluminum oxide, boron carbide, and the like. By “lapping composition,” Applicant means a fluid used during a process to shape the surface of a substrate, where that process includes contacting a target surface of the substrate with one or more abrasives while also contacting that target surface with the lapping composition.

The choice of abrasive depends on the type of material-a very aggressive abrasive, such as diamond will cause a deeper damage layer at the surface. Damage penetration can be reduced by decreasing the load on the sample and the plate speed as the final thickness is approached.

After lapping, the sample can be polished using chemo-mechanical suspensions of, for example, colloidal silica (0.125 micron) or aluminum oxide (0.3 micron). The slurry suspensions comprising one or more abrasives suspended in Applicant's lapping composition are pumped continuously over the plate.

As a general matter, the lapping process using Applicant's lapping composition comprises the steps of providing a substrate, where that substrate comprises a target surface, where that target surface may comprise a metal surface, a ceramic surface, a polymeric material, such as for example polycarbonate, or combinations thereof; and the like; providing one or more abrasives; providing Applicant's lapping composition; mounting the substrate in a lapping machine comprising a moveable lapping/polishing surface, wherein in certain embodiments the one or more abrasives may be disposed on the lapping/polishing surface; providing Applicants' lapping composition, contacting the target surface with Applicant's lapping composition, where in certain embodiments the one or more abrasives may be disposed in Applicant's lapping composition; and moving the lapping/polishing surface against the target surface.

A number of factors influence the quality of surfaces shaped by these methods including the size and composition of the particular abrasive grit employed as well as the amount of pressure applied to the surface. Fluids are often also cascaded upon the part during these operations. Among other functions, such fluids remove heat during machining. In addition, such fluids lubricate the abrasive/surface contact area. Such fluids also remove swarf from the part. As those skilled in the art will appreciate, swarf comprises metallic/ceramic filings or shavings removed by a cutting tool.

Rapid swarf removal is desirable in order to efficiently shape the part as well as reproducibly produce smooth, high quality surfaces. Hence it is desirable that the machining fluid exhibits a significant affinity for the surface of the material being shaped. In certain embodiments, such an affinity includes chemisorption upon the ceramic or metallic material; such that its swarf is wetted, dispersed within, and ultimately washed away by the cascading machining fluid.

The invention will be described herein as embodied in a lapping composition useful in the manufacture of read/write heads for computer hard disks. The following description of Applicant's composition, and uses thereof, is not meant, however, to limit Applicant's invention to the manufacture of such hard disks, or to the manufacture of data storage devices in general, as the invention herein can be applied to surface preparation of metals, ceramics, and the like. In addition, Applicant's compositions are useful in a myriad of applications, including without limitation polishing and/or chemical mechanical polishing of various substrates, removal of metal particles from filters disposed in waste water treatment plants, manufacture of semiconductor devices, and the like.

As one example, the manufacture of read/write heads for computer hard disks, and the manufacture of the hard disks, includes one or more lapping processes. As those skilled in the art will appreciate, such computer hard disks comprise rotatable disks comprising one or more magnetic materials. Information is written to, and read from, such magnetic disks using a read/write head.

As those skilled in the art will appreciate, computer hard disks are rotatably disposed in a disk drive unit such that the magnetic disk rotates rapidly as information is written thereto and/or read therefrom. In order to prevent the read/write head from damaging the disk surface when that disk is rapidly rotating, it is critical that the read/write head be planarized so that it exhibits minimal surface roughness.

There is an on-going need to maximize the storage density in such computer hard disks. In order to increase that storage density, the fly height between the rotating disk and the read write head is continually decreasing. As a result, increased demands are being placed upon surface quality of both the read-write head and the hard disk.

One such read/write head is often referred to as a Giant Magnetoresistive (GMR) Head. Such GMR Heads comprise a metallized ceramic material. GMR Heads typically comprise TiC-Alumina ceramic, sometimes called “AlTiC,” that has been metallized with a variety of ferrous and non-ferrous alloy layers. Prior art GMR Head lapping methods utilize fluids comprising a diamond abrasive dispersed in a mixture of water, various alcohols, and other additives. In order to prevent corrosion of its GMR Head metal layers which would adversely effect the Head's electromagnetic properties and operational performance within the computer hard drive.

These prior art GMR Head lapping methods are inefficient, exhibiting low AlTiC and metallized layer material removal rates (MRR). A low MRR is undesirable from a manufacturing standpoint because the MRR often comprises a rate-limiting step in the production of read/write heads. In addition, such prior art lapping fluids are highly alkaline, i.e. pH>10. Moreover, these prior art lapping compositions are not biodegradable. The alkalinity in combination with the non-biodegradability of these prior art compositions results in significant handling and disposal costs and concerns.

In contrast, Applicant's lapping composition is derived from natural products and are biodegradable. In addition, Applicant's lapping composition poses minimal environmental concerns. Moreover, Applicant's lapping method using Applicant's lapping fluids has a high MRR rate. Applicant's lapping composition is water-based, and includes additives comprising a combination of hydroxyl and carboxylic acid/carboxylate functionalities.

### SUMMARY OF THE INVENTION

Applicant's invention includes a composition useful for removing swarf from the surface of a ceramic or metallic object while that surface is being polished. In certain embodiments, Applicant's composition is formed by mixing in water an acid selected from the group consisting of citric acid, glycolic acid, tartaric acid, and gallic acid, and a base selected from the group consisting of monoethanolamine, triethanolamine, diglycolamine, guanidine, choline, and potassium hydroxide.

### DETAILED DESCRIPTION OF THE PREFERRED EMBODIMENTS

In certain embodiments, Applicant's lapping composition comprises one or more salts of hydroxy carboxylic acids. In certain embodiments, Applicant's lapping composition comprise salts of one or more alpha hydroxy acids (AHC). AHC comprise compounds having structure I, which comprises one or more hydroxyl groups attached to a first carbon atom, where that first carbon atom is covalently bonded to a second carbon atom comprising a carboxyl group.

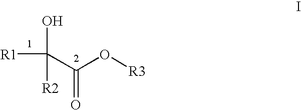

In certain embodiments, Applicant's lapping composition includes one or more of amine and/or alkali neutralized salts of citric, glycolic, tartaric acid, and/or gallic acid. In the citric acid embodiments, R1 is CH₂—CO₂—R4, and R2 is CH₂—CO₂—R5. In the glycolic acid embodiments, R1 is methyl and R2 is hydrogen. In the tartaric acid embodiments, R1 is hydrogen and R2 is C(H)(OH)—CO₂—R6. In these embodiments, R3, R4, R5, and R6, are each independently selected from the group consisting of hydrogen, an ammonium salt, such as tetramethylammonium hydroxide, an alkali metal ion, and alkaline earth metal ion, a guanidinium cation IV, a choline cation V, and the like.

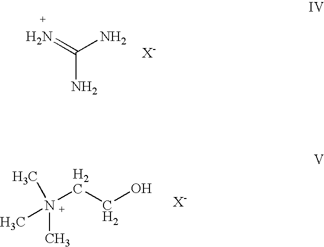

In certain embodiments, Applicant has discovered that lapping compositions comprising citric acid show enhanced lapping MRR performance. Table I, below, summarizes MRR using citric acid based lapping compositions. Lapping was conducted using a Crane Lapmaster Model 15 lapping machine comprising a 15 inch diameter diamond lapping film adhered to the lapping platen.

TABLE I
MRR Lapping Performance of Various Citrate Salts

| | | Solu- | Avg. | MRR |
|---|---|---|---|---|
| Formu- | | tion | MRR | Relative to |
| lation | Component | pH | (g/min.) | CONTROL |
| A | DGA Citrate Tribasic | 8.94 | 0.00121 | 303% |
| B | DGA Citrate Dibasic | 5.06 | 0.00138 | 345% |
| C | MEA Citrate Tribasic | 8.5 | 0.00135 | 338% |
| D | MEA Citrate Dibasic | 5.23 | | |
| E | MEA Citrate Tribasic/ | 8.8 | 0.00122 | 305% |
| | Na Polyaspartate | | | |
| | Blend | | | |
| F | Na Polyaspartate | 8.1 | 0.00095 | 238% |
| G | Na Citrate Tribasic | 8.2 | 0.00142 | 355% |
| H | TEA Citrate Tribasic | 6.8 | 0.00101 | 253% |
| I | TEA Citrate Tribasic/ | 5.05 | 0.00127 | 318% |
| | Na Polyaspartate | | | |
| | Blend | | | |
| J | TMAH Citrate Dibasic | 5.19 | 0.00137 | 343% |
| K | MEA Citrate Tribasic | 8.8 | 0.00147 | 368% |
| | Poly Sodium Aspartate- | | | |
| | co-diglycol Aspartamide | | | |
| CON- | Control Conventional | 10 | 0.00040 | — |
| TROL | GMR Head Lapping Fluid | | | |

“DGA” comprises Diglycolamine. “MEA” comprises monoethanolamine. “TEA” comprises triethanolamine. “TMAH” comprises Tetramethylammonium Hydroxide. Na Polyaspartate was Baypure DS 100 product supplied by Bayer Corp. (Pittsburgh, Pa.) having approximately 1500 Dalton molecular weight

Poly Sodium Aspartate-co-diglycol Aspartamide was prepared via aminolysis ring opening reaction of succinimide repeat units within 3000 Dalton Polysuccinimide (PSI) (Bayer Polymers Pittsburgh, Pa.) dissolved in DMSO solvent. Solutions having <30 wt. % 3000 Dalton MW PSI solute are desirable due to apparent PSI solubility and solution viscosity limitations. Diglycolamine was added dropwise to the PSI/DMSO solution at room temperature accompanied by rapid stirring to produce a dark read colored solution. Suitable lapping fluid aspartamide copolymers should be prepared via reaction of between 0 and 75 mol. % of PSI succinimide repeat units with diglycolamine. The remaining, unreacted SI repeat units in the aspartamide copolymer are hydrolyzed via reaction with aqueous NaOH solution in 1:1 molar stoichiometry producing the desired Poly Sodium Aspartate-co-Diglycol Aspartamide copolymer.

Formulations A through K, inclusive, and the Control, had identical citrate Molality within Distilled H₂O, namely 0.214 Moles Citrate/Kg H₂O solvent. Formulations A through K, inclusive, were prepared via dissolution of anhydrous citric acid in distilled water followed by dropwise addition of amines accompanied by rapid stirring until a product having desired stoichiometry was obtained. Because TMAH reagent was used in its pentahydrate crystalline salt form, this material was first dissolved in distilled water prior to its addition to aqueous citric acid solution.

Sodium citrate tribasic was purchased from Aldrich Chemical Company (Milwaukee, Wis.).

As those skilled in the art will appreciate, dissolution of anhydrous citric acid was highly endothermic, producing a solution having a temperature below about 25° C., i.e. room temperature. Such an endothermic dissolution is advantageous because the chilled solution produced compensated for the exotherm produced from the subsequent citric acid neutralization.

As those skilled in the art will appreciate, the pKa values for the various amines used follows the order of:
TMAH>>Diglycolamine≈Monoethanolamine>>Triethanolamine

During lapping, AHC compounds are believed to strongly chemisorb onto the AlTiC GMR Head specimen surfaces. As the ceramic material becomes abraded, the adsorbed AHC compounds impart a significant anionic charge to the swarf particles. Significant interparticle electrostatic repulsion facilitates rapid removal of the swarf from the specimen during lapping.

In order to minimize corrosion of the GMR Head metallic layers during lapping, it is desirable that the lapping fluid have an alkaline pH. Under alkaline conditions the surface of AlTiC acquires a net negative charge which would normally inhibit the adsorption of these anionic carboxylate compounds. The presence of hydroxyl groups on the citrate anion, however, promotes adsorption even under alkaline conditions. Such adsorption may result from the formation of highly stable cyclic ligands bound to surface metal cations or via strong hydrogen bonding interactions between the hydroxyl groups and the ceramic surfaces.

Formulations F and K showed enhanced MRRs during AlTiC Head Lapping. These rate enhancements likely result, in part, from the combination of pendent carboxylate and amide functional groups in the respective polymeric materials. The amide groups may promote polymer adsorption on the AlTiC surfaces via hydrogen bonding interactions.

A synergistic MRR effect is observed when lapping AlTiC with a Formulations E, I, and K. These Formulations include both citrate and polyaspartate species. Higher MRRs are observed by using formulations comprising a combination of these components compared to fluids containing either individual component alone.

Applicant has discovered that preferred weight ratios of the polyaspartic (or aspartamide copolymer) to citrate salt range from 0.0 to about 1. In certain embodiments, Applicant's lapping formulation comprises a weight ratios of the polyaspartic (or aspartamide copolymer) to citrate salt range from about 0.1 to about 0.5.

Tables II and III recites Formulations L and M, respectively, comprising polyaspartate or aspartamide copolymer, in combination with a citrate blend.

TABLE II
FORMULATION L
Polyaspartamide Copolymer/Citrate Lapping Fluid Composition

| Component | Concentration (Wt. %) |
|---|---|
| Distilled Water | 90.7 |
| MEA Citrate Tribasic | 7.3 |
| Poly Sodium Aspartate-co-diglycol Aspartamide | 2.0 |
| (33 mol. % polymer repeat units amidated) | |

TABLE III
FORMULATION M
Polyaspartate/Citrate Lapping Fluid Composition

| Component | Concentration (Wt. %) |
|---|---|
| Distilled Water | 69.43 |
| Triethanolamine Citrate Tribasic | 25.9 |
| Sodium Polyaspartate (Baypure DS 100) | 4.67 |

In certain embodiments, Applicant's lapping composition comprises one or more species selected from the genus of compounds commonly known as flavonoids. Such flavonoids can be obtained from naturally-occurring materials, including without limitation green tea, brown tea, coffee, grapes, and the like. For example, grape extract is also rich in polyphenolic flavonoids. As those skilled in the art will appreciate, such flavonoids comprise compounds having one or more benzene ring moieties with two or more hydroxyl groups attached to those aromatic ring structures.

In certain embodiments, Applicant's lapping composition includes vanillin and/or vanillin derivatives made via reaction of vanillin's aldehyde moiety. Vanillin has been found to inhibit corrosion. In addition, the aldehyde group comprises functionality that allows vanillin to be grafted onto a polymer backbone via reaction with amines, i.e. formation of a Schiff Base, or reaction with a urea, or a reaction with other phenolic group moieties. As those skilled in the art will appreciate, Vanillin is nontoxic, has a pleasant fragrance, and is available from both natural and synthetic sources. As those skilled in the art will further appreciate, Vanillin is structurally similar to catechol having two adjacent oxygen-containing groups attached on an aromatic ring, where one of those groups comprises a methyl ether.

In certain embodiments, Applicant's lapping composition further includes compounds comprising hydroxyl substituted benzoic acids. In certain embodiments, Applicant's lapping composition is formed using gallic acid, Compound II where R7 is OH. In certain embodiments, Applicant's lapping composition includes Compound II wherein R7 is selected from the group consisting of OH, O—R16, N(R17)(R18), and the like, wherein R16 is selected from alkyl, alkali metal cation, alkaline earth cation, cation IV, cation V, and the like, and wherein R17 and R18 are selected from hydrogen, alkyl, aryl, phenyl, and the like.

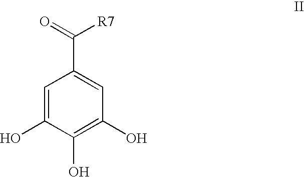

In certain of these embodiments, gallic acid is dispersed in distilled water at concentrations similar to those listed in Table I. Due to the highly acidic nature of gallic acid, Applicant neutralizes the aqueous gallic acid solution using a variety of amines, alkali hydroxides, choline derivatives, guanidine derivatives, or TMAH prior to its use in lapping formulations. Suitable bases include but are not limited to alkanolamines, alkylamines, choline, guanidine derivatives, and the like. Alkaline lapping solutions are desirable to minimize corrosion which may occur during lapping of metallic surfaces. The reaction stoichiometry required to neutralize Applicant's gallic acid embodiments is a function of the pKa of the particular base used.

As a general matter, at least one equivalent of base is used for each equivalent of gallic acid. As a further general matter, Applicant has found it desirable to have lapping fluid solutions comprising a pH greater than 8. As those skilled in the art will appreciate, such a resultant pH requires excess equivalents of base with respect to the gallic acid used.

For example, a 0.216 M aqueous solution of gallic acid was prepared having a pH of 3.05. Addition of 0.0429 mol. of ethanolamine to 200 ml of this solution corresponding to a 1:1 molar acid/base raised the pH to 6.89. Further ethanolamine was added to give a 1.18 amine/acid molar ratio. This formulation had a clear green color with a pH of 8.72. Table IV lists the composition of this Formulation N.

TABLE IV
FORMULATION N
Gallic Acid Salt Lapping Fluid Composition

| Component | Concentration (Wt. %) |
|---|---|
| Distilled Water | 94.0 |
| Ethanolamine | 2.1 |
| Gallic Acid | 3.9 |

AlTiC bars were lapped using the Formulations recited in Table V under the same conditions as detailed in Table I above.

TABLE V
MRR Lapping Performance of Various Gallate-Derived Salts

| | | Solu- | | MRR |
|---|---|---|---|---|
| Formu- | | tion | Avg. MRR | Relative to |
| lation | Component | pH | (g/min.) | CONTROL |
| O | MEA Gallate | 8.72 | 0.00093 | 233% |
| P | Potassium Gallate | 8.98 | 0.00110 | 275% |
| | (1:1 mole ratio | | | |
| | KOH/Gallic Acid) | | | |
| Q | Potassium Gallate | 10.1 | 0.00154 | 385% |
| | (3:1 mole ratio | | | |
| | KOH/Gallic Acid) | | | |
| R | Potassium Gallate | 9.1 | 0.00181 | 453% |
| | (3:1 mole ratio | | | |
| | KOH/Gallic Acid) | | | |
| | AGED 48 HOURS | | | |
| S | Potassium Gallate | 9.1 | 0.00144 | 360% |
| | (Freshly Prepared) | | | |

Formulation R is formed using the same starting materials as Formulation Q. Formulation R is aged, however, for 24 hours before use. During that 24 hour period, the color of the solution changes from a clear, light green color to a very dark green color. In addition, the pH of Formulation R is less than the pH of Formulation Q.

It is known in the chemical arts that Gallic acid dimerizes under aqueous alkaline conditions to form Ellagic acid derivatives, Compound III, where R10, R11, R12, and R13, are selected from the group consisting of ammonium salts, alkali metal ions, alkaline earth ions, guanidinium ions, choline cations, and the like.

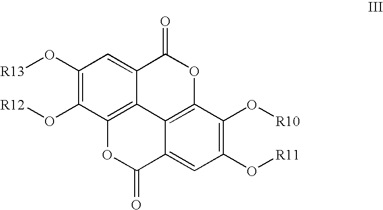

Gallic acid derived Formulations 0 through S are useful because the aromatic hydroxyls are deprotonated at alkaline pH and strongly adsorb upon the alumina surface. Applicant has found that citric acid derived formulations appear to be less strongly adsorbed at alkaline pH values compared to gallic acid embodiments 0 through S.

In certain embodiments, Applicant's composition comprises polyphenolic compounds other gallic acid/gallates/gallamides. Such polyphenolic compounds include tannins; soluble black tea extracts; soluble green tea extract, such as for example Sunphenon 100S from Taiyo Kagaku Co., Ltd.); quebracho bark extract used for leather tanning; tannic acid; humic acid; catechol; pyrogallol, d, 1-Dopamine; d, 1-DOPA derivatives; N-Acetyl Dopamine; and the like.

In certain embodiments, Applicant's composition comprises Catechin derivatives such as those found in tea extract, including but not limited to catechin, epicatechin, gallocatechin, epigallocatechin, epicatechin gallate, gallocatechin gallate, epigallocatechin gallate,

In certain embodiments, Applicant's composition includes Caffeoyl Derivatives, such as for example including esters, amides, and salts of caffeic acid. In certain embodiments, Applicant's composition includes for example Procyanidin derivatives, Theaflavins, Thearubins, Phenolic Flavanol derivatives, Galloyl Glucose derivatives, Rugosin D, Enterochelin, Chlorogenic acid and its derivatives, Tyrosine derivatives, Alkyl Catechol derivatives including but not limited to tert-Butyl Catechol, and combinations thereof.

In certain embodiments, Applicant's composition includes Phenol Ether derivatives including but not limited to guaiacol, veratrole, 2-methoxy phenol, mandelic acid, and the like, and combinations thereof. In certain embodiments, Applicant's composition includes one or more Orthoquinone derivatives.

Gallic acid, Ellagic acid, and related polyphenolic derivatives, exhibit low toxicity, and can be readily obtained via the hydrolysis of tannic acid, a natural product derived from wood by products. As those skilled in the art will appreciate, Tannic acid is essentially composed of a mixture of polysaccharides having a high concentration of gallic acid esterified along the saccharide polymer chains.

In certain embodiments, Applicant's lapping composition comprises polymeric materials. In certain of these polymeric materials embodiments, Applicant's polymeric materials include a plurality of pendent gallic acid moieties and/or gallic acid derivatives, such as without limitation gallamide moieties. In certain embodiments, these polymeric materials are formed by reacting a polymer which includes a plurality of Polysuccinimide repeat units VI with an amino-terminated gallamide. In certain embodiments, n is in the range from 1 to about 5000 wherein Ra is selected from the group consisting of alkyl, aryl, succinimde, aspartic acid, and aspartate salt, and wherein Rb is selected from the group consisting of alkyl, aryl, succinimde, aspartic acid, and aspartate salt.

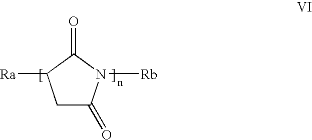

In certain embodiments, Applicant's polymeric material which includes a plurality of gallamide moieties is formed from polysuccinimide XI, wherein n is in the range from 5 to 30. In certain embodiments, polysuccinimide XI has a number average molecular weight of about 3,000 Daltons.

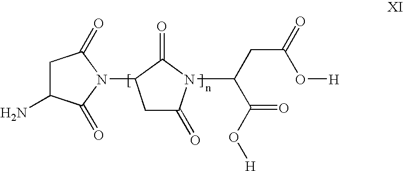

In certain embodiments, methyl gallate, Compound II wherein R7 is O-Me, is reacted with a diamine to give an amino-terminated gallamide. Such diamines include, without limitation, diamino-terminated hydrocarbons, diamino-terminated polyethers, diamino-terminated polyamides, and the like. In other embodiments, methyl gallate is reacted with an amino alcohol to give a hydroxyl-terminated gallamide.

For example, in certain embodiments methyl gallate is reacted with diamine VII to give amino-terminated gallamide VIII wherein R15 is selected from the group consisting of hydrogen, alkyl, oxyalkyl, aryl, phenyl, and oxyphenyl, and wherein (m) is greater than or equal to 1 and less than or equal to about 10.

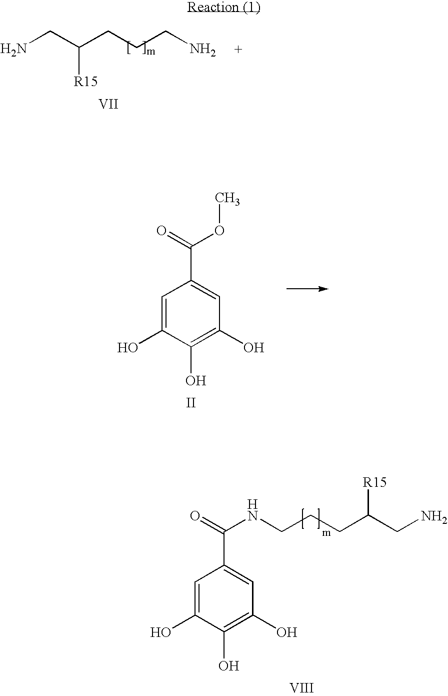

Amino-terminated gallamide VIII is then reacted with polysuccinimide VI to form derivatized polyaspartamide IX

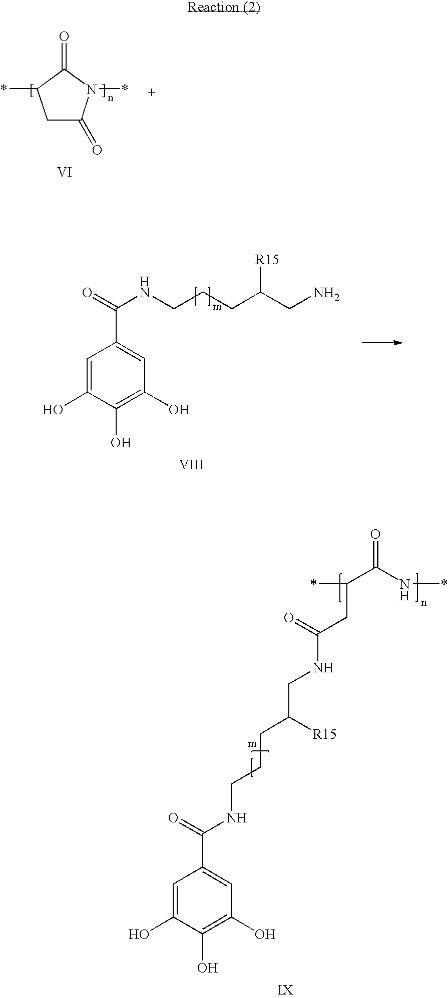

### EXAMPLE 1

### Synthesis of Compound VIII

About 6.60 g (0.036 mole) of Methyl-3,4,5-trihydroxybenzoate was dissolved in about 46.4 g of Dimethyl Sulfoxide (DMSO) by gently heating the mixture at 45° C. for about 20 minutes with stirring. As those skilled in the art will appreciate, DMSO is a polar, aprotic solvent having low toxicity and good biodegradability. Other polar, aprotic solvents may be used in place of, or in combination with, DMSO. Such polar, aprotic solvents include, for example, N— Methyl Pyrrolidone, Sulfolane, Tetrahydrofuran, or Dimethyl Sulphone.

The resulting DMSO solution was then added to a 250 ml round bottom flask which had been previously flushed with inert nitrogen gas. About 10.368 g (0.08922 mole) of 2-methyl-1,5-pentanediamine, Compound VII, wherein R15 is methyl and (m) is 1, is sold in commerce by DuPont under the tradename Dytek A, were then added to that DMSO solution, and the resulting reaction mixture was heated under vacuum at about 160° C. for about 8 hours. Diamine 2-methyl-1,5-pentanediamine was selected on the basis of its nucelopilicity combined with its high pKₐ₁ value of 11.2.

During the reaction, methanol was removed from the reaction mixture as it was formed as the product from the aminolysis reaction occurring between the gal late ester and Diamine 2-methyl-1,5-pentanediamine. A clear, slightly reddish colored solution comprising about 26.6 weight percent compound VIII was obtained.

### EXAMPLE 2

### Polyaspartamide IX/X Preparation

About 7.82 g of 3,000 MW Polysuccinimide, polymer VI, sold in commerce by Bayer Chemicals Corp. Pittsburgh, Pa. under the tradename Baypure, was dissolved in about 33.0 g DMSO at 55° C. This yielded a solution comprising about 19.1 weight percent polymer VI

About 19.72 g of a DMSO solution of compound VIII, from Example 1, was diluted with about 8.61 g additional DMSO. This DMSO solution was rapidly mixed with the previously prepared DMSO/polymer VI solution.

In certain embodiments, a stoichiometric excess of Compound VII was added in an amount such that all the succinimide moieties were ring-opened. In other embodiments, less than a stoichiometric amount of VII was used, thereby giving co-polymer X having both succinimide linkages and substituted aspartamide linkages.

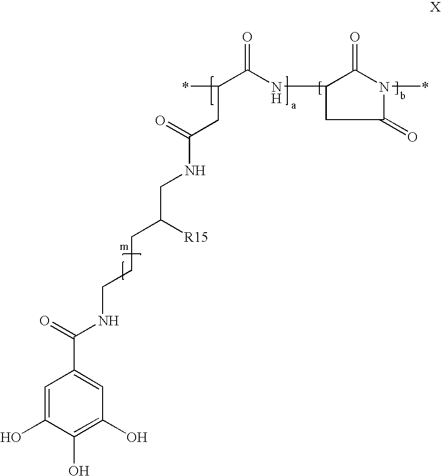

For example, in one embodiment about one-fourth of the succinimide repeat units in PSI VI were ring-opened using Reaction 2 to give co-polymer X wherein (a) is about 0.25 (b), and wherein (a+b) is in the range of 4 to about 5000. The structure shown for polymer X should not be interpreted to mean that polymer X is necessarily a block copolymer. Rather in certain embodiments, the (a) repeat units are are randomly dispersed among the (b) repeat units.

An exotherm was noticed upon mixing accompanied by a darkening of the solution such that it became sanguine in appearance. The solution was allowed to stand at room temperature for 30 minutes resulting in a clear, homogeneous, sanguine colored solution.

Applicant has discovered that grafting a plurality of gallamide groups onto a polyaspartic acid/aspartamide backbone gives a gallamide polymer that is water soluble, where that aqueous solution does not phase separate or precipitate upon standing. In contrast, the corresponding aqueous solutions of potassium gal late having similar molar concentration of gallate moieties darkens and phase separates as particulates upon standing. As noted above, gallic acid is known to undergo oxidative coupling when present in alkaline aqueous solutions.

Significantly, Applicant has found that attaching pendant gallamide groups to a polymer backbone allows the product to stay in solutions longer. In addition, Applicant has found that using a polymer comprising pendent gallate/gallamide groups rather than a plurality of lower molecular weight gallate anions has the added advantage of forming electrosteric stabilized dispersions. Individual gallate anions comprise small discrete charges and impart electrostatic charges upon the swarf as it is removed during the polishing operation. Gallamide functionalized polymers, on the other hand also electostatically charge the particles but by virtue of them being attached to a backbone enables the adsorbed polymer chain to form a brush like structure upon the swarf; further hindering particulate agglomeration.

### EXAMPLE 3

### Lapping Solution Formulation

About 196.5 g of a solution comprising about 1.08 weight percent NaOH in water was combined with a DMSO solution of co-polymer X wherein a is about 0.25(b). The reaction mixture was stirred for about 1 hour at room temperature to give a solution having a pH of about 10.82. Table VI summarizes the composition of the aqueous lapping fluid prepared.

TABLE VI

| Component | Concentration (Wt. %) |
|---|---|
| Sodium Polyaspartic-co-aspartamide | 5.91 |
| copolymer (25% pendant gallamide) | |
| DMSO | 18.5 |
| Distilled Water | 75.59 |

AlTiC bars were then lapped using the method described about. An average MRR of 0.00133 g/min. was obtained using this lapping composition of Table VI.

The measured MRR for the composition of Table VI is significantly greater than the MRR of 0.00095 g/min. MRR measured when lapping AlTiC using a 25 weight percent solution of Baypure DS100.

In certain embodiments, Applicant's lapping composition comprises an alkylated or acylated derivative of gallamide polymer IX. In these embodiments, Applicant reacts polymer IX, wherein n is in the range of 1 to 5000, with an aqueous sodium borate solution to give borate-protected polymeric gallamide XXII. 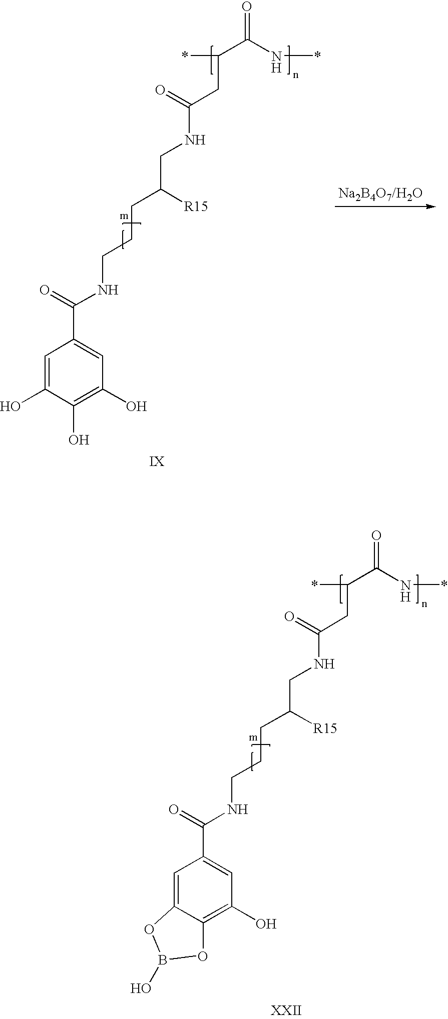
In one embodiment, borate-protected gallamide polymer XXII is then reacted with sodium chloroacetate or sodium bromoacetate and NaOH in water to give gallamide polymer XXIII. That aqueous solution is then acidified to give gallamide polymer XXIV. Applicant has discovered that the reaction byproduct NaCl increases the ionic strength of the aqueous reaction medium thereby “salting out” gallamide polymer XXIV from that NaCl/H₂O reaction medium.

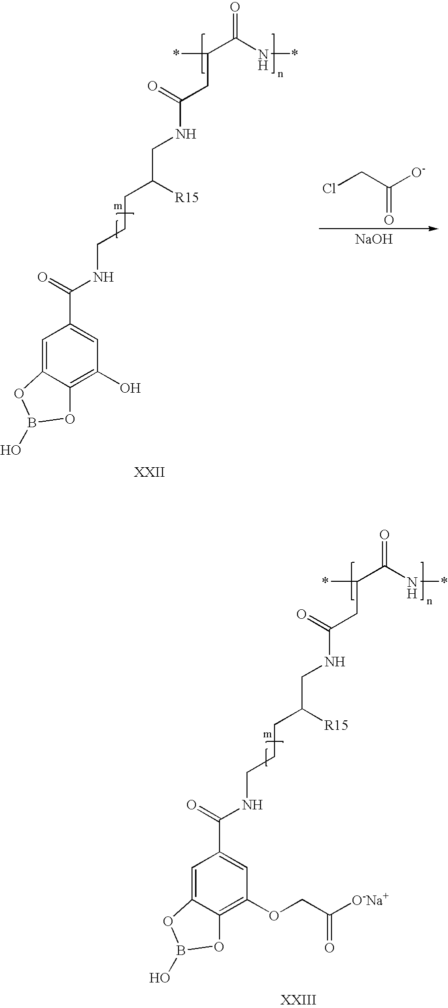

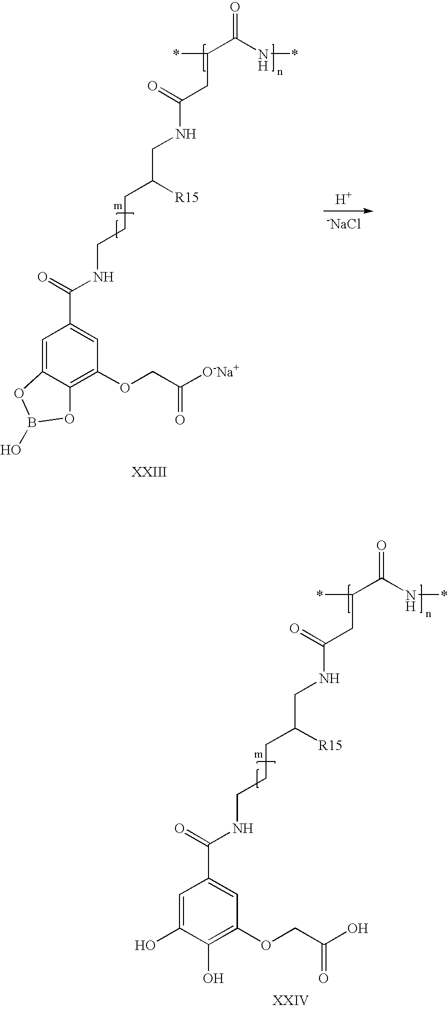

In other embodiments, Applicant reacts gallamide polymer 1× with dimethylsulfate in DMSO to give the monomethylated gallamide polymer XXIV. The synthetic reaction scheme described and shown herein to form gallamide polymers XXII, XXIII, and XXIV from starting gallamide polymer IX may be similarly used to form monomethylated gallamide XXV starting with gallamide polmer X. This same reaction scheme can be used to form a monomethylated gallamide or gallate ester from Compound II.

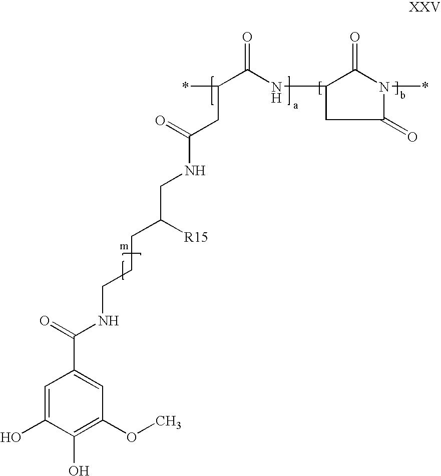

In other embodiments of Applicant's composition, pendant amine functionalized Gallamide VIII is reacted with other polymers to produce polymeric lapping fluid additive having both electrostatic and steric stabilization to polished swarf particles.

Such other polymers include, for example, maleic anhydride copolymers, such as Scripset 1000—Polystyrene-co-maleic anhydride polymer obtained from Sartomer Company Inc. Exton, Pa., or Gantrez AN-Polymethylvinylether-co-maleic anhydride obtained from International Specialty Products Inc. Wayne, N.J. In these embodiments, the amine functionalized gallamide VIII is reacted with the maleic anhydride copolymer in a polar aprotic solvent, followed by dissolution in aqueous alkaline solution to produce a polyelectrolyte lapping fluid additive.

In yet other embodiments, the amine functionalized gallamide VIII is with isocyanate prepolymers, acrylate oligomers, and/or epoxy oligomers, to produce water dispersible lapping fluid additives.

In other embodiments, polyethyleneimine (PEI) is reacted with methyl gallate to give a polymeric material comprising pendent gallamide moieties. As those skilled in the art will appreciate, PEI has a brush like structure, and is known in the art for its ability to serve as a dispersant in a wide variety of ceramic slurry formulations.

Applicant's gallamide functionalized PEI brush polymer is synthesized by adding methyl gallate to PEI either neat, or in a solvent, and allowing that reaction mixture to stand for several days at room temperature. During this reaction period, an aminolysis reaction occurs between the primary amine groups present on PEI and methyl gallate.

In certain embodiments, a stoichiometric excess of methyl gallate is used to react with essentially all of the amino moieties in the PEI polymer. Heating the reaction mixture in a nitrogen atmosphere at temperatures greater about. 67° C., i.e. the boiling point of methanol, drives this aminolysis reaction to completion. Aqueous solutions of these functionalized PEI polymers typically have pH values greater than about 9, and are suitable lapping fluids.

As those skilled in the art will appreciate, AlTiC comprises a two phase blend of Titanium Carbide, TiC, and Aluminum Oxide powders sintered together. TiC has an acidic isoelectric point (IEP) near pH 3.3. On the other hand, Aluminum Oxide is basic having an isoelectric point near pH 10. In water, AlTiC swarf comprises a mixture of the two particles. TiC particles acquire a negative electrostatic surface charge whereas Aluminum Oxide particles acquire a positive surface charge. Due to mutual attraction between these two different kinds of charged particles, the swarf has a tendency to agglomerate.

To minimize, and hopefully prevent, swarf agglomeration, Applicant has found it desirable to impart identical surface charges to both the TiC particles and the Aluminum Oxide particles. Applicant has further found that citrate moieties and gallate moieties manifest an affinity, i.e. a selective adsorption, towards Aluminum Oxide particles and TiC particles, respectively. Therefore, embodiments of Applicant's composition comprises blends of hydroxycarboxylate moieties, including without limitation citrate and/or polyaspartic acid-co-hydroxyethylaspartamide) anions, in combination with phenolate anions, including without limitation gallates, catecholates, pyrogallates, tannates, and the like. Applicant has found that such compositions comprising these afore-described blends to be very useful aqueous lapping fluids for AlTiC, where those lapping fluids exhibit high Material Removal Rates.

### EXAMPLE 4

A. Preparation Of Solution “A”

About 5.58 grams of anhydrous Citric acid were dissolved in about 96 grams of distilled water. Thereafter, about 5.52 grams of monoethanolamine were added to that solution. This amount of MEA was sufficient to prepare a monoethanolammonium citrate tribasic species in solution.

B. Preparation Of Solution “B”

About 5.48 grams of gallic acid were added to about 96 grams of distilled water followed by rapid addition of about 4.89 grams of KOH pellets with stirring.

C. Lapping Composition

Solutions “A” & “B” were then combined to give a lapping composition comprising about a 50/50 mole mixture of citrate and gallate anions. AlTiC bars were then lapped using this solution and were found to have average Material Removal Rates of 0.002 g/min.

In certain embodiments, Applicant's lapping composition includes one or more catechin-aldehyde polymeric materials. Referring to Compound XI below, where R20 is OH, Compound XI comprises catechin or epi-catechin depending on the orientation of the R20 hydroxyl group.

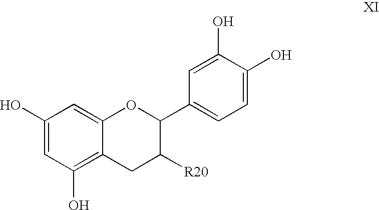

Reacting Compound XI with more than a two fold stoichiometric excess of aldehyde XII in acidic condition gives a polymeric material which includes the repeat unit XIII, wherein (n) is between 1 and 5000, and wherein R21 is selected from the group comprising alkyl, phenyl, aryl, —COOH, —C(O)-Alkyl, hydroxyphenyl, and combinations thereof. 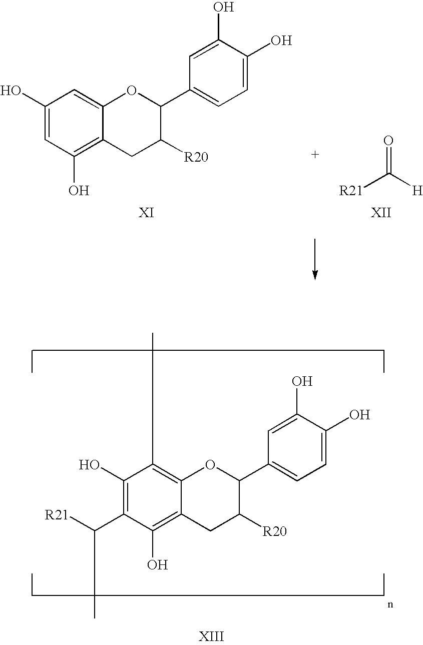
In certain embodiments, R20 comprises OH. In other embodiments, R20 comprises O-Galloyl, i.e. structure XIV. 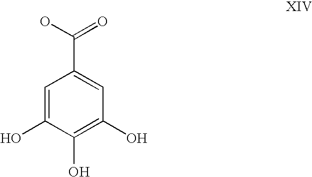
The preparation of polymeric material XIII is described in Regioselective Synthesis and Structures of (+)-Catechin-Aldehyde Polycondesates, Macromol. Chem. Phys., 204, 1863-1868 (2003), which is hereby incorporated herein in its entirety.

In other embodiments, Applicant reacts Compound XI with about a 1:1 stoichiometric amount of aldehyde XII to give Compound XV. The preparation of Compound XV is described in Characterization of (+)-Catechin-Acetaldehyde Polymers: A Model for Colloidal State of Wine Polyphenols, J. Agric. Food Chem., 45, 1045-1049 (1997), which is hereby incorporated herein in its entirety.

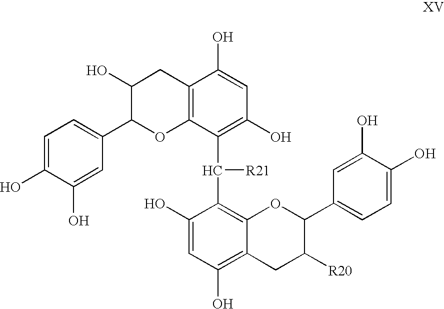

In certain embodiments, Applicant's lapping composition includes Compound XV, wherein R20 and R21 are as described above. In certain embodiments, a plurality of moieties comprising Compound XV are reacted with Polymer XI to give a polymeric material comprising a plurality of pendent groups comprising Compound XV.

While the preferred embodiments of the present invention have been illustrated in detail, it should be apparent that modifications and adaptations to those embodiments may occur to one skilled in the art without departing from the scope of the present invention as set forth in the following claims.

1. A lapping composition formed by mixing in water an acid selected from the group consisting of citric acid, glycolic acid, tartaric acid, and gallic acid, and a base selected from the group consisting of monoethanolamine, triethanolamine, diglycolamine, guanidine, choline, and potassium hydroxide.

2. The composition of claim 1, further comprising poly sodium aspartate.

3. The composition of claim 1, further comprising poly sodium aspartate-co-diglycol aspartamide.

4. A composition useful for removing swarf from the surface of a ceramic and/or metallic object while that surface is being lapped, wherein said composition is formed by adding to gallic acid in water a base selected from the group consisting of monoethanolamine, potassium hydroxide, and triethanolamine.

5. A lapping composition formed by adding to a polysuccinimide having structure 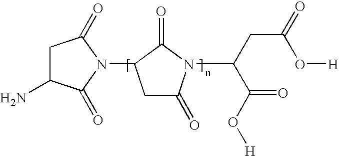
a gallamide having the structure 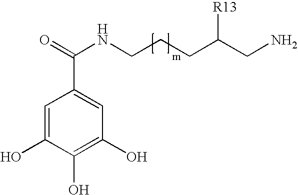
wherein n is between 5 and 30 and wherein m is greater than or equal to 1 and less than or equal to about 10, and wherein R13 is selected from the group consisting of hydrogen, alkyl, oxyalkyl, phenyl, and oxyphenyl.

6. The lapping composition of claim 5, wherein said polysuccinimide has a molecular weight of about 3,000 Daltons.

7. (canceled)

8. (canceled)

9. (canceled)

10. (canceled)

11. (canceled)

12. A lapping composition comprising a salt having the structure 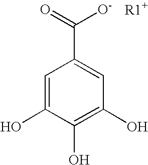
wherein R1+ is selected from the group consisting of an alkali metal cation, an alkaline earth cation, a diglycolammonium cation, a monoethanolammonium cation, a triethanolammonium cation, a tetramethylammonium cation, a guanidinium cation, and a choline cation.

13. A lapping composition comprising a compound having the structure 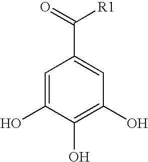
wherein R1 is selected from the group consisting of OH and N(R2)(R3), wherein R2 and R3 are each selected from the group consisting of alkyl and phenyl.

14. A lapping composition comprising a polymeric substituted gallamide having the structure 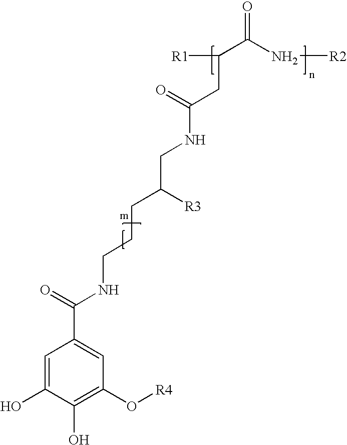
wherein R1 is selected from the group consisting of alkyl, aryl, succinimide, aspartic acid, and aspartate salt, and wherein R2 is selected from the group consisting of alkyl, aryl, succinimide, aspartic acid, and aspartate salt, and wherein n is between 1 and 5000, and wherein m is greater than or equal to 1 and less than or equal to about 10, and wherein R3 is selected from the group consisting of hydrogen, alkyl, oxyalkyl, phenyl, and oxyphenyl, and wherein R4 is selected from the group consisting of hydrogen, methyl, and —CH₂—COOH.

15. (canceled)

16. (canceled)

17. A method to shape the surface of a substrate, comprising the steps of:
providing a substrate, wherein said substrate comprises a target surface, wherein that target surface comprises a metal surface, a ceramic surface, or a combination thereof;
providing one or more abrasives;
providing a lapping composition;
contacting said target surface with said one or more abrasives while contacting said target surface with said lapping composition;
wherein said lapping composition comprises a salt having the structure 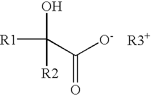
wherein R1 is selected from the group consisting of hydrogen, methyl, and CH₂—CO₂⁻R4⁺, and wherein R2 is selected from the group consisting of hydrogen, CH₂—CO₂⁻R5⁺, and C(H)(OH)—CO₂⁻R6⁺, and wherein R3⁺, R4⁺, R5⁺, and R6⁺, are each selected from the group consisting of an alkali metal cation, an alkaline earth cation, a diglycolammonium cation, a monoethanolammonium cation, a triethanolammonium cation, a tetramethylammonium cation, a guanidinium cation, and a choline cation.

18. (canceled)

19. (canceled)

20. (canceled)

21. (canceled)

22. A method to shape the surface of a substrate, comprising the steps of:
providing a substrate, wherein said substrate comprises a target surface, wherein that target surface comprises a metal surface, a ceramic surface, or a combination thereof;
providing one or more abrasives;
providing a lapping composition;
contacting said target surface with said one or more abrasives while contacting said target surface with said lapping composition;
wherein said lapping composition comprises a compound having the structure 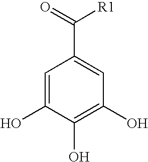
wherein R1 is selected from the group consisting of OH and N(R2)(R3), wherein R2 and R3 are each selected from the group consisting of alkyl and phenyl.

23. (canceled)

24. (canceled)

25. (canceled)
